(19) United States
(12) Patent Application Publication
(10) Pub. No.: US 2009/0266575 A1
(43) Pub. Date: Oct. 29, 2009

(54) Electric Wire for Automobile

(76) Inventors: Jun Yoshimoto, Mie (JP); Shinji Kamei, Mie (JP)

Correspondence Address: CASELLA & HESPOS, 274 MADISON AVENUE, NEW YORK, NY, 10016, US

(21) Appl. No.: 11/989,800

(22) PCT Filed: Jul. 3, 2006
(86) PCT No.: PCT/JP2006/313246

§ 371 Date: Jan. 31, 2008

(30) Foreign Application Priority Data
Aug. 4, 2005 (JP) 2005-226364

(51) Int. Cl. H01B 3/44; H01B 5/08

(52) U.S. Cl. 174/110 R; 174/128.1

(57) ABSTRACT

An electric wire for an automobile has a core wire section and an outer circumferential wire section. The core wire section is formed by spirally winding six element wires around one element wire, where each element wire is made of stainless steel having elongation of 30% or more and tensile strength of 920 MPa or higher and the element wires have the same diameter in the range of 0.127 mm±10%. The circumferential wire section is formed by spirally winding twelve element wires around the core wire section, where the twelve element wires are wound close to each other in a single layer, each element wire is made of copper having tensile strength of 220 MPa or higher, and the element wires have the same diameter in the range of 0.127 mm±10%. The wire is light, small, strong and has good bending characteristics.

### BACKGROUND OF THE INVENTION

1. Field of the Invention

The present invention relates to automotive wires, and, in particular, relates to an automotive wire structured to have a core wire portion consisting of stainless strands and a circumferential wire portion consisting of copper strands.

2. Description of the Related Art

An electric wire for internal wiring (wire harness), used to provide, for example, electric connection of electrical equipment in an automobile, is required not only to have a small diameter, a low electric resistance, a favorable high corrosion resistance, and a good contact with a terminal, but also to exhibit excellent mechanical properties, i.e., a sufficient tensile strength and a favorable bending property. To meet these requirements, various inventions are made. For example, the invention disclosed in JP 09-147361A not only provides a multi-core wire by binding together numerous stainless thin wires each having a favorable corrosion resistance and mechanical properties, and numerous copper thin wires each having a favorable conductivity, but also forms a core wire portion by binding together a plurality of stainless thin wires, with a numerous copper thin wires located around the core wire portion; furthermore, the ratio of the cross-sectional area of the stainless thin wires to the cross-sectional area of the copper thin wires is set in a predetermined range.

However, with recent technological progress and intensified competition, the standards or demands for reduced diameter, conductivity, tensile strength, bending property and the like of automotive wires are becoming increasingly strict. In particular, with recent electronic development, the requirement for reduced diameter of automotive wires for passenger cars, trucks, motorcycles and the like is becoming very strict.

Therefore, it is necessary to replace currently used automotive wires with ones having lighter weight and smaller diameter. However, in consideration of external force applied during work for making a connection with a terminal, or the workability thereof, vibration created during use and the like, tensile strength and bending property need to be equal to or higher than those of the currently used electric wires even if diameter is reduced. The electric wires reduced in diameter and weight should compare favorably with the currently used electric wires even though the former are partially inferior to the latter because of reduced diameter.

Further, if electric wires whose nominal cross-sectional area and nominal diameter are equal to those of the currently used electric wires are to be utilized, they are required to have conductivity equal to or higher, higher tensile strength and bending property, and lighter weight than those of the currently used wires.

Furthermore, in the case of a multi-core wire, concaves and convexes are formed on the circumference thereof. Thus, the thickness of insulating coating tends to be increased. Moreover, the thickness of the insulating coating has to be increased to a certain extent so as to prevent the linear insulating coating from being left in concaves, formed by the concaves and convexes at the circumference of the multi-core wire, when the insulating coating is peeled off by a tool to make a connection with a terminal. In particular, in the case of using insulating coating containing a fire retardant, the thickness of the insulating coating has to be increased.

Therefore, there has been a demand for an electric wire in which concaves and convexes or the like do not exist at the circumference of the conductive portion, insulating coating is thin, diameter and weight are reduced accordingly, and the cost is low.

Besides, in order to prevent the application of heat resulting from energization, it is also demanded that, when sudden external force is exerted, stainless wires having higher electric resistance are first broken.

### SUMMARY OF THE INVENTION

The present invention has been made to satisfy the above-described demands, and provides an automotive wire in which twelve copper thin wires (hereinafter called “copper strands”) having predetermined properties are adhered to one another and spirally wound around a core wire in which seven stainless thin wires (hereinafter called “stainless strands”) having predetermined properties are adhered to one another.

Furthermore, contrivance is also made on the cross-sectional areas (diameters) of the stainless strands and copper strands.

Moreover, the copper strands are located around the circumference of the core wire portion, consisting of the stainless strands, so as to be wound in a single-ply manner and mutually adhered, and in this state, the entire electric wire is compressed (pressed) toward the center from outside, thereby changing the cross-sectional shape of the entire twelve copper strands into a pipe shape, and reducing diameter. In accordance with this, since concaves and convexes on the surface of the circumferential wire portion are eliminated, and thickness of the insulating coating can be reduced.

The invention provides an automotive wire comprising: a core wire portion formed by adhering seven stainless strands each having an elongation of 30% or more, a tensile strength of 920 MPa or more, and a diameter of 0.127 mm within a tolerance of ±10%; and a circumferential wire portion formed by spirally winding twelve copper strands with equal diameters around the core wire portion in a single-ply manner so as to be mutually adhered, the copper strands each having a tensile strength of 220 MPa or more, and a diameter of 0.127 mm within a tolerance of −10% to +15%.

According to the invention of this claim, the core wire portion consisting of the stainless strands, each having a large elongation and a high strength, principally takes charge of tensile force, while the circumferential wire portion consisting of the copper strands, each made of pure copper, electrolytic copper or the like having a favorable conductivity, principally takes charge of conductivity, thus allowing both properties to be excellent.

Further, the elongation, tensile strength, diameter and number of the respective stainless strands and copper strands are suitably determined, thus realizing high conductivity, high tensile strength, high bending property, reduced diameter, and reduced weight.

Furthermore, since the automotive wire is made of copper and stainless, a high corrosion resistance is achieved.

In addition, the copper strands are spirally wound around the stainless core wire portion; therefore, like a spring or a coil, stress produced during bending is reduced, thus achieving a high bending property.

Moreover, the stainless strands also take charge of stress produced during fiercely repeated vibrations, thus achieving a high resistance to vibration.

Furthermore, since only the copper strands are located circumferentially, a good contact with a terminal can be achieved.

It should be noted that the higher the (rupture) elongation and tensile (rupture) strength of the stainless strands are, the more preferable. However, these properties are incompatible (e.g., if the tensile strength is high, the elongation is low). Considering this fact and the cost, it is determined that the elongation is to be 30% or more and a tensile strength is to be 920 MPa or more, although the tensile strength itself is preferably 930 MPa or more and is more preferably 940 MPa or more, specifically which is high tensile stainless steel.

The invention also may be directed to an automotive wire comprising: a core wire portion formed by adhering seven stainless strands each having an elongation of 30% or more, a tensile strength of 920 MPa or more, and a diameter of 0.127 mm within a tolerance of ±10%; and a circumferential wire portion formed by spirally winding twelve copper strands with equal cross-sectional areas around the core wire portion in a single-ply manner so as to be mutually adhered, and by forming the overall cross-sectional shape of the copper strands into a pipe shape, the copper strands each having a tensile strength of 220 MPa or more and a cross-sectional area equivalent to that of a wire material with a diameter of 0.127 mm within a tolerance of −10% to +15%.

The above-described aspect of the invention is implemented by forming the overall cross-sectional shape of the copper strands, constituting the circumferential wire portion into a pipe shape, thus achieving further reduced diameter of the automotive wire.

Furthermore, since concaves and convexes at a circumference of the circumferential wire portion are reduced, the thickness of insulating coating does not have to be 0.3 mm or more in order to prevent the insulating coating from remaining linearly in the concaves of the circumferential wire portion when the insulating coating is peeled off at a field work. As a result, since the insulating coating can be thinned, the automotive wire can accordingly be further reduced in weight and diameter.

The invention also preferably provides an automotive wire based on the above-described automotive wire, characterized in that the overall cross-sectional shape of the copper strands, constituting the circumferential wire portion, is formed by compression from outside toward the core wire portion.

According to this aspect of the invention, the overall cross-sectional shape of the twelve copper strands is formed by compressing (pressing) the entire twelve copper strands from outside toward the core wire portion at a time. Therefore, a more tightly and orderly formed cross-sectional shape is obtained, unlike the case where molding is performed, for example, by winding copper strands molded in advance.

The invention also preferably provides an automotive wire based on the above-described automotive wire, characterized in that, around the central one of the stainless strands, the other six stainless strands having equal diameters are spirally wound to form the core wire portion.

According to this aspect of the invention, in the central one of the stainless strands, bending stress produced when the entire electric wire is bent is originally small, and the surrounding stainless strands are spirally wound; therefore, the bending stress is reduced on the same principle as spring or a coil. Thus an excellent bending property of the core wire portion is achieved.

Further, the automotive wire is structured so that tensile force applied from outside is exerted on all the stainless strands in a unified manner, and therefore, the tensile strength is also improved.

If a core wire is formed by a single wire, there is the possibility of occurrence of a so-called hitting in which a hard core wire is brought into direct contact with a terminal when crimped onto the terminal. However, in the invention of this claim, the possibility of the problem decreases and eventually the electrical contact with a terminal becomes better, since the core wire portion is formed by the seven wound wires, thickness of the core wire portion is substantially increased, although its has the same cross-sectional area, and the circumferential copper strands are located so as to be mutually adhered.

Moreover, due to the number and location of the stainless strands, the cross section of the core wire portion is virtually formed into a circular shape, thus making it easy to wind the copper strands around the core wire portion.

The invention also preferably provides an automotive wire based on the above-described automotive wire, characterized in that the core wire portion is formed by the seven stainless strands having equal diameters.

In this aspect of the invention, the stainless strands have equal diameters. Combined this fact and the fact that the six stainless strands are wound, there is no problem in terms of space for the winding, thus allowing operation to be easily performed, and allowing materials to be arranged and managed easily.

The invention may also provide an automotive wire based on the above-described automotive wire, characterized in that all of the stainless strands or the six stainless strands except the central one of the stainless strands have diameters smaller than those of the copper strands.

According to this aspect of the invention, compared with the case where the diameters of the stainless strands are equal to those of the copper strands, the ratio of the total cross-sectional area of the stainless strands to the total cross-sectional area of the copper strands is reduced, thus providing the automotive wire having a further reduced diameter or a more favorable conductivity while satisfying the required tensile strength.

The invention may further provide an automotive wire based on the above-described automotive wire, characterized in that 20%≦{A/(A+B)}≦40% is satisfied, where A represents the total cross-sectional area of the stainless strands, and B represents the total cross-sectional area of the copper strands.

According to this aspect of the invention, there is achieved the automotive wire in which the tensile strength or bending property and conductivity are well-balanced.

The invention may still further provide an automotive wire based on the above-described automotive wire, characterized in that the total cross-sectional area of the circumferential wire portion is in the range of 0.14 mm² to 0.19 mm².

According to this aspect of the invention, an automotive wire, in which the tensile strength or bending property and conductivity are well-balanced, can be provided as a current automotive wire having a nominal cross-sectional area of about 0.22 mm², and also the automotive wire can be used instead of a current automotive wire having a nominal cross-sectional area of about 0.5 mm².

Still another aspect of the invention provides an automotive wire based on the above-described automotive wire, characterized by comprising: a core wire portion formed by spirally winding six stainless strands around one stainless strand, all of the stainless strands having equal diameters and each having an elongation of 30% or more, a tensile strength of 920 MPa or more, and a diameter of 0.127 mm within a tolerance of ±10%; and a circumferential wire portion formed by spirally winding twelve copper strands around the core wire portion in a single-ply manner so as to be mutually adhered, the copper strands having equal diameters and each having a tensile strength of 220 MPa or more and a diameter of 0.127 mm within a tolerance of ±10%.

The embodiment of the invention described in the preceding paragraph is perceived as one of the best modes for carrying out the invention having a diameter and a weight equivalent to those of a current electric wire having a nominal cross-sectional area of about 0.22 mm², can be used instead of a current automotive wire having a nominal cross-sectional area of about 0.5 mm².

Further, since only the copper strands each having a favorable conductivity are located circumferentially, a good electrical contact with a terminal is provided.

Furthermore, since the copper strands, each having an electric conductivity higher than that of the stainless strand and a bending fatigue strength lower than that of the stainless strand, are circumferentially and spirally wound around the core wire portion consisting of the stainless strands, bending stress, produced when the entire automotive wire is bent, is reduced on the same principle as a spring or a coil, thus increasing the number of bendings that can be endured, and resulting in an improvement in bending fatigue strength. Therefore, the automotive wire has an excellent bending property as a whole.

A further embodiment of the invention of claim 10 provides an automotive wire based on the above-described automotive wire, characterized in that the winding pitch of the respective strands of the core wire portion differs from that of the respective strands of the circumferential wire portion.

According to this aspect of the invention, since the winding pitch of the stainless strands differs from that of the copper strands, the copper strands will not fall into concaves between the stainless strands. As a result, the cross section of the circumferential wire portion, and eventually the cross section of the entire electric wire, can be more easily formed into a circular shape.

It should be noted that, in this case, the stainless strands are preliminarily twisted (wound) at a certain pitch length, and then the copper strands and the stainless strands (second time) are twisted at a pitch length about twice as much as that of the first time. It should also be noted that, in this case, if the stainless strands and the copper strands are wound in different directions, the stainless strands easily come apart at the time of crimping, thus making it difficult for a so-called hitting to occur above and below a terminal swaging part, and making it difficult for a holding force after the crimping to be decreased.

The invention may also provides an automotive wire based on the above-described automotive wire, characterized in that the winding pitch of the respective copper strands is larger than that of the respective stainless strands.

According to this aspect of the invention, since the copper strands are not excessively wound, the electric resistance will not be increased.

Further, since the copper strands will not fall into concaves between the stainless strands at an outer surface of the core wire portion, the winding is facilitated.

It should be noted that the winding pitch of the stainless strands itself is preferably large for preventing the stainless strands easily coming apart at the time of crimping.

Another aspect of the invention provides an automotive wire based on the above-described automotive wire, characterized in that, for one of the seven stainless strands, which is centrally located, a material having a hardness higher than that of each of the other six stainless strands is selected during fabrication.

According to this aspect of the invention, since the six surrounding stainless strands are work-hardened by winding, the properties of all the stainless strands become identical to one another when the fabrication of the automotive wire is completed.

Another embodiment of the invention provides an automotive wire based on the above-described automotive wire, characterized in that the core wire portion has an elongation lower than that of the circumferential wire portion on the occasion of rupture.

According to this aspect of the invention, rupture due to excessive elongation occurs first at the core wire portion, thus avoiding the situation where energization is performed while only the core wire portion is not ruptured, which overheats the automotive wire and causes fire.

The invention of claim 14 provides an automotive wire based on the above-described automotive wire, characterized by having an insulating coating around the circumferential wire portion, the thickness being 0.33 mm or less.

According to this aspect of the invention, even if a fire retardant is added to the insulating coating, a part of the insulating coating will not be left linearly in the circumferential wire portion when the insulating coating is peeled off at a field work. In addition, the insulating coating is thin, thus providing the automotive wire having favorable workability and further reduced weight and diameter.

Yet another aspect of the invention provides an automotive wire based on the above-described automotive wire, characterized in that the thickness of the insulating coating is 0.2 mm within a tolerance of ±10%.

According to this aspect of the invention, since the insulating coating is thinner, the automotive wire having further reduced weight and diameter is provided.

In the present invention, the core wire portion that takes charge of tensile strength is formed by the seven thin stainless strands having predetermined properties; thus, all the strands take charge of tensile force, applied from outside, in a unified manner to maintain sufficient tensile strength. As for bending, bending stress is small, because each strand bends independently, resulting in the automotive wire that is easily bent by small external force, and has an extremely favorable bending fatigue property.

Further, since the circumferential copper strands are located so as to be mutually adhered and wound, the possibility of occurrence of a so-called hitting is reduced in which a hard core wire is brought into direct contact with a terminal when crimped onto the terminal.

Furthermore, if the core wire portion is structured to have seven wound wires, it is more unlikely to cause hitting compared with the case where the core wire portion is formed by a single stainless strand.

In addition, since only the copper strands each having a favorable conductivity are located circumferentially, the automotive wire has a good contact with a terminal.

Moreover, since the central stainless strand produces small bending stress and the other stainless strands and the copper strands located circumferentially around the stainless strands are each spirally wound, the stress produced due to bending is reduced, thus causing not only a large bending by a small force, but also increasing bending fatigue strength.

Further, the copper strands are wound around the core wire portion consisting of the stainless strands having high strength, and thus have no possibility of rupture even when repeatedly exposed to fierce vibrations.

Furthermore, due to compression toward the core wire portion, the outer surface of the circumferential wire portion consisting only of the copper strands becomes substantially smooth, thus making it possible to reduce the thickness of the surrounding insulating coating film, and providing the automotive wire that is further improved in both of reduced diameter and reduced weight. Moreover, when the insulating coating is peeled off to make a connection with a terminal, since the outer surface of the copper strands is smooth, the situation that insulating coating is left in concaves between thin wires as in a normal multi-core wire is avoided, thus facilitating the operation.

Besides, the following example of the specific effect can be mentioned. If the electric wire of the present invention, having a nominal cross-sectional area of 0.22 mm², is used instead of a conventional electric wire (AVSSH 0.5 mm²), having a nominal cross-sectional area of 0.5 mm², in an automotive sensor or signal circuit, the weight of engine harness can be reduced by 15% or more.

### BRIEF DESCRIPTION OF THE DRAWINGS

FIG. 1 is a schematic diagram showing a cross section of an automotive wire according to a first embodiment of the present invention.

FIG. 2 is a schematic diagram showing a cross section of an automotive wire according to a second embodiment of the present invention.

### DETAILED DESCRIPTION OF THE PREFERRED EMBODIMENTS

Hereinafter, the present invention will be described based on best mode embodiments thereof. It should be noted that the present invention will not be limited to the embodiments described below. Various modifications can be made to the following embodiments within the scope identical to the present invention and the scope of its equivalence.

### First Embodiment

### (Overall Structure)

First, the overall structure of principal part of an automotive wire according to the present embodiment will be described.

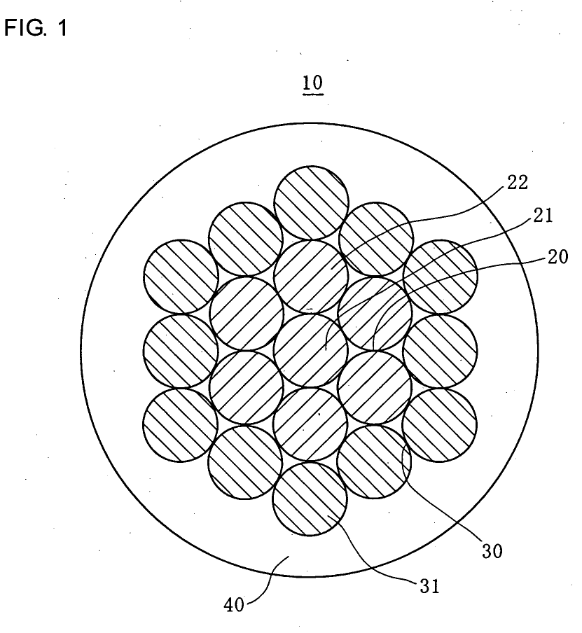

FIG. 1 schematically shows a cross section of the completed automotive wire 10 according to the present embodiment. In FIG. 1, the reference numeral 20 represents a core wire portion consisting of seven stainless strands in total, the reference numeral 21 represents the central one of the stainless strands, and the reference numeral 22 represents the stainless strands wound around this central stainless strand 21 in single-ply and spiral manner. Further, the reference numeral 30 represents a circumferential wire portion consisting of twelve copper strands in total, and the reference numeral 31 represents the each of the copper strands. Furthermore, the reference numeral 40 represents insulating coating.

### (Core Wire Portion)

Around the single stainless strand 21, the six stainless strands 22, each having a thickness equal thereto, are spirally wound in single-ply and tight manner, thus forming the core wire portion 20. It should be noted that the six surrounding stainless strands 22 are pressed to some degree and slightly elongated or work-hardened during the winding. Accordingly, a somewhat harder material is selected for the central stainless strand 21 in advance.

Further, the stainless strands each has a diameter of 0.127 mm, and are wound at a pitch of 5 to 30 mm.

It should be noted that the cross section of each of the six surrounding stainless strands 22 is not a perfect circle in a strict sense since they are wound, but this point is neglected in the diagram because the error is negligible. And the same goes for the copper strands.

### (Circumferential Wire Portion)

Around the core wire portion 20, the twelve copper strands 31, each having a thickness equal to that of each stainless strand, are spirally wound in single-ply and tight manner, thus forming the circumferential wire portion 30. It should be noted that the copper strands and the stainless strands are wound in the same direction, and the winding pitch of the copper strands is equal to or greater than that of the stainless strands, thereby preventing the copper strands 31 from falling into concaves between the stainless strands 22 at the circumference of the core wire portion 20. Therefore, the respective copper strands 31 are spirally wound around along an outer edge line of the stainless strands 22 located at the circumferential side of the core wire portion 20.

### (Insulating Coating)

The insulating coating 40 contains 140 to 200 w/t parts of magnesium hydroxide as a fire retardant for 100 w/t parts of olefin polymer, and has a thickness of 0.3 mm so as to cover circumferential parts of the copper strands 31.

Examples of Specific insulating materials include polyethylene and polypropylene.

It should be noted that although the above-mentioned non-halogen material is preferable as a coating material, PVC coating or olefin polymer containing a halogen fire retardant may also be used.

### (Test Results)

### (Bending Fatigue Test Results)

The electric wire having the above-described structure was subjected to a bending rupture test. The test method was as follows. In a constant temperature oven at 20° C., a weight of 250 g was suspended from a lower end of the electric wire, the electric wire was slightly caught by a mandrel (cylindrical) with R=6 mm, the electric wire was bent by 90° rightward and leftward along the circumferential part of the mandrel, and the test was carried out at a rate of 90 times/minute while one reciprocation was counted as a single time. In addition, for every 500 times, it was checked whether or not any of the stainless strands or the copper strands was ruptured.

The test results indicated that no anomaly was found until 2500 times, but the two copper strands were ruptured at 3000 times. Moreover, the eleven copper strands were ruptured at 3500 times. All the strands were ruptured at 4000 times, but the electric wire could be determined to have sufficient bending fatigue strength.

### (Tensile Test Results)

Among strength (tensile rupture strength) requirements for automotive harness assembly, the strictest requirement is set for crimped part strength. Further, if the nominal cross-sectional area is 0.5 mm², the strength should be 70 N or more. Actually, in terminal crimping, the strength is reduced to 70% in general, and therefore, a tensile strength of 100 N is needed at minimum.

The tensile test results indicated that the automotive wire of the present embodiment had a conductor strength of 111 N (and a rupture strength of 129 N). Accordingly, the automotive wire of the present embodiment sufficiently satisfies the requirements.

### (Outer Diameter and Weight)

The electric wire has an outer diameter of 1.14 mm.

The electric wire weighs 3.1 g/m, realizing reduced diameter and reduced weight while maintaining sufficient strength.

### Comparative Example 1

A conventional automotive wire having a nominal cross-sectional area of 0.5 mm² is formed by binding together nineteen copper wires each having an outer diameter of 0.19 mm.

The tensile rupture weight of this electric wire is 140 N or more, and in bending test, no rupture occurred until 1000 times but the eleven copper wires ruptured at 1500 times. Therefore, in terms of mechanical strength, this electric wire stands comparison with the embodiment of the present invention. However, this electric wire has an outer diameter as large as 1.6 mm, and weighs 7.1 g/mm.

### Comparative Example 2

Six pure copper strands each having an outer diameter of 0.215 mm were wound around a single strand, and these strands were combined by compression and coated with an insulating material having a thickness of 0.2 mm, thus producing a prototype of an electric wire.

This electric wire had an outer diameter as small as 0.95 mm, but tensile rupture weight was as low as 65 N.

### Comparative Example 3

Around a stainless strand having an outer diameter of 0.203 mm, six copper strands each similarly having an outer diameter of 0.203 mm were spirally wound, thus producing an automotive wire.

This electric wire had a tensile strength as low as 76 N. Further, the bending fatigue strength of this electric wire was lower than that of the embodiment of the present invention. This is believed to be due to the fact that the cross-sectional area of the stainless strand makes up only 14% of the total cross-sectional area of metal part including the copper strands.

### Comparative Example 4

Around a stainless strand having an outer diameter of 0.280 mm, eight copper strands each having an outer diameter of 0.175 mm were wound, thus producing an automotive wire.

This electric wire had a tensile strength of about 110 N, satisfying the requirement. This is believed to be due to the fact that the cross-sectional area of the stainless strand makes up about 24% of the total cross-sectional area of metal part including the copper strands. However, since the diameter of the stainless strand is large, the bending fatigue strength was reduced.

Furthermore, in a terminal connection test, a so-called bottom hitting, in which the stainless strand was brought into direct contact with a terminal, occurred.

### Second Embodiment

The present embodiment is implemented by compressing (pressing) copper strands so as to be combined.

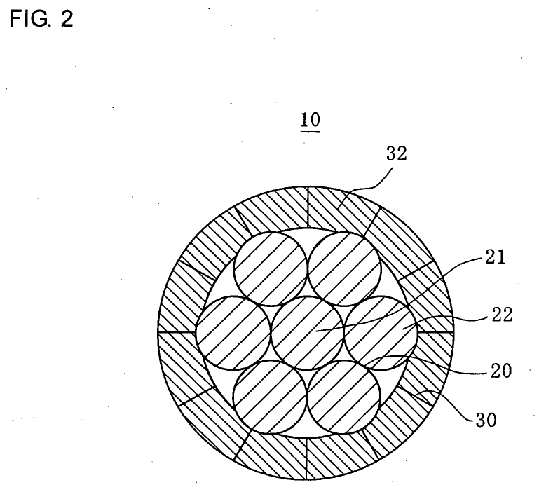

FIG. 2 shows the state of the compressed circumferential wire portion of the electric wire shown in FIG. 1. In this diagram, the reference numeral 32 represents the copper strands, which have been deformed and combined by pressing, i.e., the copper strands constituting the circumferential wire portion.

The copper strands are made of pure copper having a tensile rupture strength of 230 MPa, meaning that the copper strands are made of a soft material. Therefore, the overall cross section of the twelve copper strands, constituting the circumferential wire portion, is easily formed into a pipe shape due to compression from outside toward the core wire with the use of dies.

On the other hand, stainless is far harder than (i.e., has Young's modulus higher than that of) pure copper or electrolytic copper. Therefore, unlike the copper strands 32, the stainless strand 21 is not greatly changed in cross-sectional shape, although the stainless strand 21 is elongated to some extent in the wire direction, when the electric wire is pressed during which it is forcedly passed through a pore of dies. Meanwhile, the stainless strand 21 is suitably adhered to the copper strands 32 and to the other stainless strands 22.

It should be noted that in the present embodiment, the circumferential wire portion virtually has no concaves and convexes, and therefore, the thickness of insulating coating is set to be 0.2 mm so as to further reduce diameter and weight although not shown in the diagram.

### Other Embodiments

An automotive wire comprising copper strands and stainless strands each having a diameter of 0.114 mm, and an automotive wire comprising copper strands and stainless strands each having a diameter of 0.140 mm were also produced. In both cases, the automotive wires exhibited high tensile strength and high bending property, and the former particularly had a high bending property while the latter particularly had a high tensile strength.

1. An automotive wire comprising:
a core wire portion formed by adhering seven stainless strands each having an elongation of 30% or more, a tensile strength of 920 MPa or more, and a diameter of 0.127 mm within a tolerance of ±10%; and
a circumferential wire portion formed by spirally winding twelve copper strands with equal diameters around the core wire portion in a single-ply manner so as to be mutually adhered, the copper strands each having a tensile strength of 220 MPa or more, and a diameter of 0.127 mm within a tolerance of −10% to +15%;
wherein 20%≦{A/(A+B)}≦40% is satisfied, where A represents the total cross-sectional area of the stainless strands,and B represents the total cross-sectional area of the copper strands.

2. An automotive wire comprising:
a core wire portion formed by adhering seven stainless strands each having an elongation of 30% or more, a tensile strength of 920 MPa or more, and a diameter of 0.127 mm within a tolerance of ±10%; and
a circumferential wire portion formed by spirally winding twelve copper strands with equal cross-sectional areas around the core wire portion in a single-ply manner so as to be mutually adhered, and by forming the overall cross-sectional shape of the copper strands into a pipe shape, the copper strands each having a tensile strength of 220 MPa or more and a cross-sectional area equivalent to that of a wire material with a diameter of 0.127 mm within a tolerance of −10% to +15%.

3. An automotive wire according to claim 2, wherein the overall cross-sectional shape of the copper strands, constituting the circumferential wire portion, is formed by compression from outside toward the core wire portion.

4. An automotive wire according to claim 2, wherein around the central one of the stainless strands, the other six stainless strands having equal diameters are spirally wound to form the core wire portion.

5. An automotive wire according to claim 4, wherein the core wire portion is formed by the seven stainless strands having equal diameters.

6. An automotive wire according to claim 2, wherein all of the stainless strands or the six stainless strands except the central one of the stainless strands have diameters smaller than those of the copper strands.

7. An automotive wire according to claim 2, wherein 20%≦{A/(A+B)}≦40% is satisfied, where A represents the total cross-sectional area of the stainless strands, and B represents the total cross-sectional area of the copper strands.

8. An automotive wire according to claim 2, wherein the total cross-sectional area of the circumferential wire portion is in the range of 0.14 mm²to 0.19 mm².

9. An automotive wire comprising
a core wire portion formed by spirally winding six stainless strands around one stainless strand, all of the stainless strands having equal diameters and each having an elongation of 30% or more, a tensile strength of 920 MPa or more, and a diameter of 0.127 mm within a tolerance of ±10%; and
a circumferential wire portion formed by spirally winding twelve copper strands around the core wire portion in a single-ply manner so as to be mutually adhered, the copper strands having equal diameters and each having a tensile strength of 220 MPa or more and a diameter of 0.127 mm within a tolerance of ±10%,
wherein 20%≦{A/(A+B)}≦40% is satisfied, where A represents the total cross-sectional area of the stainless strands, and B represents the total cross-sectional area of the copper strands.

10. An automotive wire according to claim 9, wherein the winding pitch of the respective strands of the core wire portion differs from that of the respective strands of the circumferential wire portion.

11. An automotive wire according to claim 10, wherein the winding pitch of the respective copper strands is larger than that of the respective stainless strands.

12. An automotive wire comprising:
a core wire portion formed by adhering seven stainless strands each having an elongation of 30% or more, a tensile strength of 920 MPa or more, and a diameter of 0.127 mm within a tolerance of ±10%; and
a circumferential wire portion formed by spirally winding twelve copper strands with equal diameters around the core wire portion in a single-ply manner so as to be mutually adhered, the copper strands each having a tensile strength of 220 MPa or more, and a diameter of 0.127 mm within a tolerance of −10% to +15%; wherein
around the central one of the stainless strands, the other six stainless strands having equal diameters are spirally wound to form the core wire portion, and
for central one of the seven stainless strands, a material having a hardness higher than that of each of the other six stainless. strands is selected during fabrication.

13. An automotive wire according to claim 12, wherein the core wire portion has an elongation lower than that of the circumferential wire portion on the occasion of rupture.

14. An automotive wire according to claim 11, which has an insulating coating around the circumferential wire portion, the thickness being 0.33 mm or less.

15. An automotive wire according to claim 14, wherein the thickness of the insulating coating is 0.2 mm within a tolerance of ±10%.
